(19) United States
(12) Patent Application Publication
(10) Pub. No.: US 2006/0152933 A1
(43) Pub. Date: Jul. 13, 2006

(54) Illumination device

(76) Inventors: Regine Kramer, Munich (DE); Erwin Melzner, Stephanskirchen (DE); Jurgen Heinrich, Rosenheim (DE)

Correspondence Address: CHRISTIE, PARKER & HALE, LLP, PO BOX 7068, PASADENA, CA, 91109-7068, US

(21) Appl. No.: 10/528,821

(22) PCT Filed: Sep. 22, 2003
(86) PCT No.: PCT/DE03/03211

§ 371 Date: Aug. 12, 2005

(30) Foreign Application Priority Data
Sep. 20, 2002 (DE) 202-14-879.3

(51) Int. Cl. F21V 19/00

(52) U.S. Cl. 362/382

(57) ABSTRACT

Disclosed is an illumination device comprising at least one electrical planar lamp module that is provided with a module housing, the depth of which is small compared to the light-emitting area of the planar lamp module. Said planar lamp module can be connected to other planar lamp modules. The module housing encompasses a lamp housing and a lamp frame which is connected to the lamp housing and is provided with means for mechanically connecting the lamp frame to the lamp frame of at least one additional planar lamp module.

The invention relates to an illumination device comprising at least one electrical panel lamp module according to the preamble of claim 1.

A modular lighting system is known from DE 101 15 846 A1 in which a light band of any length is generated by placing individual oblong elements side by side in a row and in which oblong fluorescent lights are housed electrically connected in series in an oblong housing which is made of up oblong support profiles of U-shaped cross-sectional profile placed side by side in a row. In order to simplify assembly and increase the flexibility during use the fluorescent lights contain in one structural unit a luminescent tube and an associated electronic ballast as well as means for detachable electrical connection with adjoining lights wherein the fluorescent lights are detachably fixed in the housing.

The known modular light system is only suitable for tubular-shaped lights arranged in series and is not suitable for the modular construction of planar lamps.

From DE 198 33 217 A1 a fluorescent tubular light is known having one or more fluorescent tubes and reflectors for the fluorescent tubes and having a cross-section which enables several such fluorescent tubular lights to be arranged in series. The housing of the fluorescent tubular lights has a rectangular cross-section and on the sides of the housing there are connecting devices with interengaging detent devices to connect several housings together in a row.

In the event of several lights arranged in series one ballast has to be provided for each light combination and is connectable to the individual lights electrically through branch plugs so that a number of electrical plugs and leads corresponding to the number of lights needs to be provided.

This known arrangement of several fluorescent tubular lights in a row has a housing profile which is characterised by connecting devices in the form of bolts and hook profiles so that a single fluorescent tubular light has an optically unassuming housing shape. The electrical connection required with each individual fluorescent tubular light furthermore produces a plurality of electrical plug connections and leads which makes this illumination device little suited for mobile use.

From DE 19830271 A1 an illumination device is known having a modular construction which consists of a lighting body and a housing holding the light body and with connecting means for mechanical connection to other similar housings and means for adapting the voltage when the operating voltage of the lighting means deviates from the mains voltage. The modules of the illumination system are joined into different length straight sections and different curved sections in order to produce an uninterrupted lighting strip.

From DE 19853424 A1 a light diode block is known whose housing wall has studs and associated hollow bodies which can be connected together in the manner of toy building blocks to make up a larger light source. The studs and hollow bodies serve both for the mechanical connection of the individual light diode blocks and for the electrical lead connection.

From EP A 0 848 206 an illumination device is known which consists either of a single holding and assembly element provided with a frame and attached to the frame with a current supply and current discharge lead or of a plurality of light-emitting faces in one common support and assembly frame which have on the sides of their lamp housing plug devices for electrical connection. The possibility for modular expansion of this illumination device is however restricted to the dimensions of the support and assembly frame which is to be made matching the illumination device as well as to planar lamps mounted side by side.

From DE A 198 33 217 a fluorescent lamp is known whose box like housing has an open front side set in the longitudinal direction of the box as the light-emitting side in which a reflector and luminescent tube are housed. On a side wall adjoining the light-emitting side the housing has a hollow profiled rail running over the entire length of the box and on the opposite side wall has a hook profile which fits into the hollow profiled rail so that when fitting two lamps together in a row the hook profile of one lamp engages positively in the opening of the hollow profiled rail of the adjoining lamp and the hooked part of the profile projects into the profiled rail. For a secure connection of the two lamps arranged in a row a bolt profile is additionally provided which is held by retaining clips and which is inserted into the hollow profiled rail of the adjacent lamp to engage in the hooked profile.

To further increase the stability and security of the connection of two or more lamps a web is provided along the edge of the light-emitting side and on the side of the first hollow profiled rail whilst a hooked strip is provided on the opposite edge and can be drawn round this web.

However since there is no possibility of separating the lamp housing and lamp frame it is not possible to dimension the lamp frame independently of the proposed lamp housing. Furthermore with this illumination device a modular expansion is only possible with illumination modules which are arranged side by side.

The object of the present invention is to provide an illumination device of the type mentioned at the beginning which enables a connection of any number of electrical panel lamp modules arranged side by side and/or one above the other to make up an illumination device with a large light-emitting surface with a small structural depth and in variable structural shape, guarantees in any combination of panel lamp modules arranged side by side or one above the other a closed optically acceptable illumination device and which is easy to handle both during assembly of several individual panel lamp modules and in the assembled state as one large-surface illumination device and which ensures a stable connection.

This is achieved according to the invention through the features of claim.

The solution according to the invention provides an illumination device which can be combined from any number of panel lamp modules arranged side by side and/or one above the other to make up one illumination device having a large light-emitting surface with a low structural depth and in different structural forms, ensures in any combination of planar light modules arranged side by side or one above the other both with light frames connected together and with one light frame encompassing all the light housings a closed, optically acceptable illumination device which is easy to handle both during assembly of several panel lamp modules and in the assembled state as a large-surface illumination device and which ensures a stable connection.

Owing to the separation of the lamp housing and the lamp frame the solution according to the invention enables in different embodiments
a) the electrical and mechanical connection of several panel lamp modules comprised of a lamp housing and a lamp frame through the end sides of the lamp frames;
b) a separated electrical connection through connectors on the lamp housings and a mechanical connection through the lamp frame which holds the lamp housing.

The lamp frame preferably has means for the mechanical connection of the lamp frame to the lamp frame of at least one further panel lamp module and has compared to the lamp housing in particular a greater depth so that there is greater freedom when connecting the lamp frames of several panel lamp modules into one large-surface illumination device as well as a problem-free cabling for the electrical connection of the panel lamp modules which is in particular not visible owing to the cabling being arranged on the back of the illumination device.

As spacers and for the flat bearing contact when fitting the panel lamp modules on a wall or shelf on a horizontal surface as well as for stacking several panel lamp modules, spacers, preferably designed as rubber buffers, are mounted in the corner regions of the back wall of the lamp housing opposite the light-emitting front side so that a spot bearing is produced away from the light-emitting glass surface of the planar lamps.

In a first variation of the solution according to the invention the lamp frame has assembly bores which are aligned flush with each other for connection with the lamp frame of at least a further panel lamp module wherein the arms of the lamp frames of the panel lamp modules being connected together are aligned flush relative to each other. For a mechanical connection of the panel lamp modules, connecting elements are fitted through the aligned assembly bores and are connected together with positive-locking and/or force-locking engagement or are brought into the locking position.

In order to produce a readily releasable connection the connecting elements consist of lateral connectors with a cylindrical connecting body whose diameter is smaller than the diameter of the assembly bores, a stop shoulder mounted at one end of the cylindrical connecting body, a lever, and of a bolt connected to the lever and guided through the cylindrical connecting body, wherein between the end of the bolt and the end of the cylindrical connecting body a groove is formed which can be adjusted in its width by actuating the lever and in which an elastic ring is mounted which can be expanded through compression.

This type of connection enables the arrangement of a number of lateral connectors corresponding to the number of assembly bores in the case of panel lamp modules arranged parallel or in series with each other, and ensures a simple connection and separation of the lamp frame.

Particularly for a fixed installation of the illumination device for example on a (positioning) wall or ceiling, screws and nuts can be provided as the connecting elements to connect the lamp frames to each other. Alternatively the connecting elements consist of bayonet-locking or dovetailed connections wherein the latter are connected together by fitting the individual lamp frames on each other.

In a preferred embodiment the lamp housing is comprised of a light housing for holding a planar lamp, a heat distribution plate at the back of the light housing remote from the light-emitting side, and of a back wall.

Owing to its modular structure this combination enables the use of different lamps in structurally identical light housings, a uniform distribution of the heat given out by the lamps as well as an individual configuration of the back wall for holding a ballast or control electronics and the electrical connections of the planar lamps.

Furthermore in this embodiment at least one contact element and at least one contact receiver element are arranged on the back wall of the lamp housing for controlling and supplying current to the panel lamp module. In particular the back wall of the lamp housing has for this purpose a central raised region projecting into the lamp frame whereby the at least one contact element and contact receiver element are multi-polar and are arranged on an end side of the raised region so that a problem-free fitting of the ballast and the lamp electronics as well as easy access to the electrical connections of the panel lamp module are ensured even where several panel lamp modules are connected together.

The accessibility to the contact elements and contact receiver elements is further improved in that the middle raised region projecting into the lamp frame is rectangular in design with a diagonal side bridging one corner and that the at least one contact element and contact receiver element are mounted on the diagonal side.

For cascading the panel lamp modules the lamp frame has in the region of at least one arm a socket for connecting with the positive locking elements, consisting of a recess for connecting with a positive locking or connecting element which connects two aligned sockets of two lamp frames together.

Furthermore the panel lamp modules or lamp housings can be connected to a power supply module through cable connections.

In order even with a number of interconnected panel lamp modules or lamp housings to be able to individually control individual panel lamp modules or groups of combined or separately mounted panel lamp modules of a large surface illumination device the contact elements have either a number of contacts for individual control and power supply of the individual electrical panel lamp modules in series which (number) corresponds to the number of electrical panel lamp modules in series, or a control and/or data bus through which the electrical panel lamp modules arranged in series can be individually addressed and controlled.

Furthermore an electric switch can be provided on the lamp housing for individually activating individual panel lamp modules.

By separating the lamp housings and lamp frame it is possible to connect the lamp frame at the light-emitting front side of the lamp housing to an accessory frame for holding a filter, shutter, colour changer or the like without straining the lamp housing containing the lighting means.

In order to make it easier to access and change for example filters or the like inserted in the accessory frame the accessory frame which is connected to the lamp frame can be folded down from the lamp frame.

Both a single panel lamp module and several panel lamp modules or lamp housings arranged in series and/or parallel to each other and connected together can be connected through the or each lamp frame to a holder which thereby holds all the panel lamp modules which make up the illumination device.

In a preferred embodiment the arms of the lamp frame preferably have centrally mounted positive or force locking engagement elements whilst the ends of the holder which more particularly consists of a supporting bracket are provided with corresponding counter positive locking elements or counter force locking engagement elements which are connected to the positive or force locking engagement elements on the arms of the lamp frame.

In a preferred embodiment the supporting bracket is designed of variable length so that in the case of a rectangular panel lamp module or lamp frame it can be fitted on either the short or long axis of the panel lamp module or illumination device made up of several panel lamp modules, and the illumination device can be pivoted about the short or long axis. A corresponding adjusting device enables different internal widths of the supporting bracket to be set.

For the alternative fixing of the panel lamp module or the illumination device made up of several panel lamp modules, a guide and socket plate is mounted on the back wall of the lamp housing in to which fixing elements are inserted which can be connected to the panel lamp module, such as for example a pivotal stud for connection to a corresponding sleeve of a tripod or wall or ceiling fixing.

For this purpose the socket and guide plate has at least two guide rails arranged either side of the insert opening, and in the insert direction of the fixing element in front of the insert opening a locking element is mounted on the back wall of the lamp housing.

The locking element consists in particular of a resilient pressure member so that on sliding the fixing element into the socket and guide plate the fixing element slides over the resilient pressure member which then engages when the fixing element is fully inserted into the socket and guide plate. For removal the locking element can be released again by pressure.

For easier handling of one or more panel modules a handle, preferably a cast plastics handle, is disposed on the side of the socket and guide plate opposite the insert opening.

The use of a flat discharge lamp as the panel lamp module is particularly suitable for the large surface illumination device according to the invention.

The idea on which the invention is based as well as individual solutions forming features of the invention will now be described in further detail with reference to embodiments of the invention illustrated in the drawings. They show:

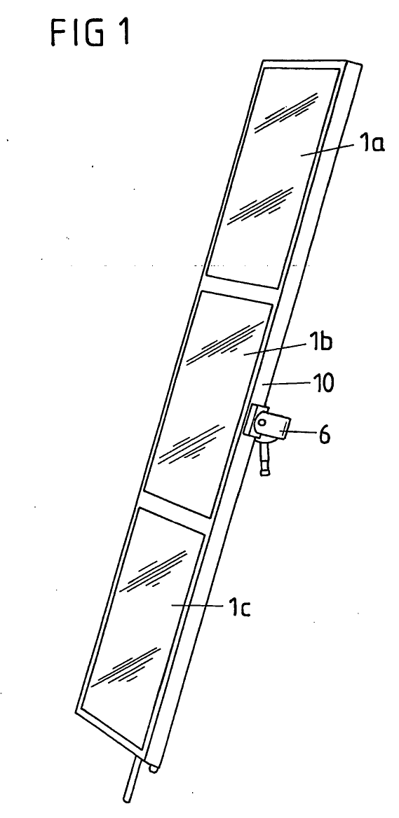

FIG. 1 a perspective view of an illumination device with three electrical panel lamp modules, connected together in series, of one modular expandable system of similar type electrical panel lamp modules;

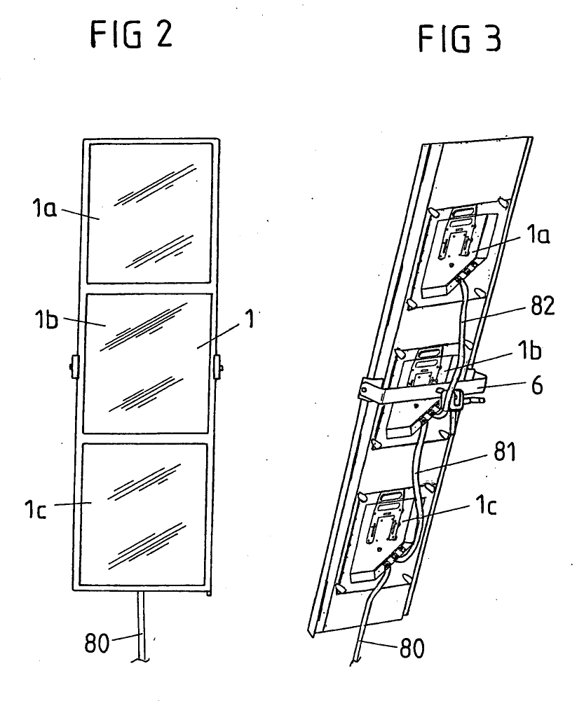

FIG. 2 a front side view of the illumination device according to FIG. 1;

FIG. 3 a perspective rear side view of the illumination device according to FIG. 1 in a first embodiment;

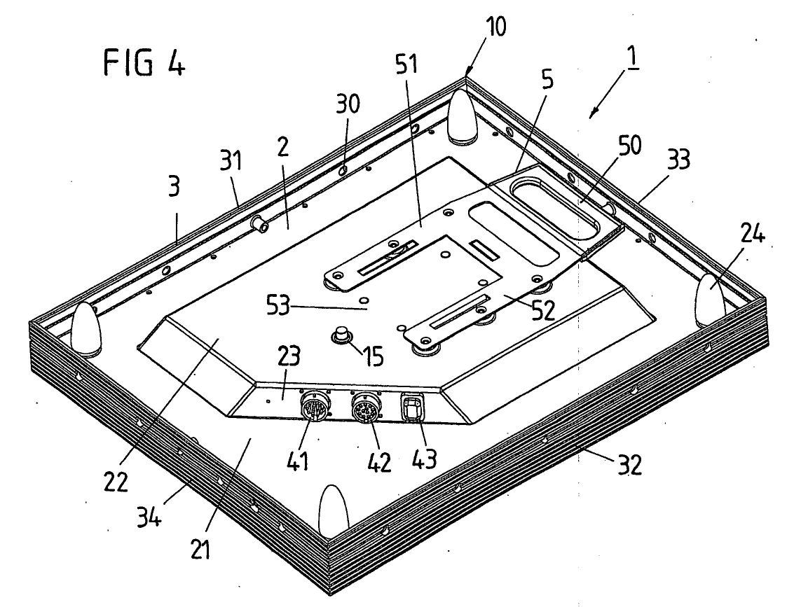

FIG. 4 a perspective view of the rear side view of a single panel lamp module in the first embodiment with a lamp frame set lower than the lamp housing;

FIG. 5 a rear side view of the panel lamp module according to FIG. 4;

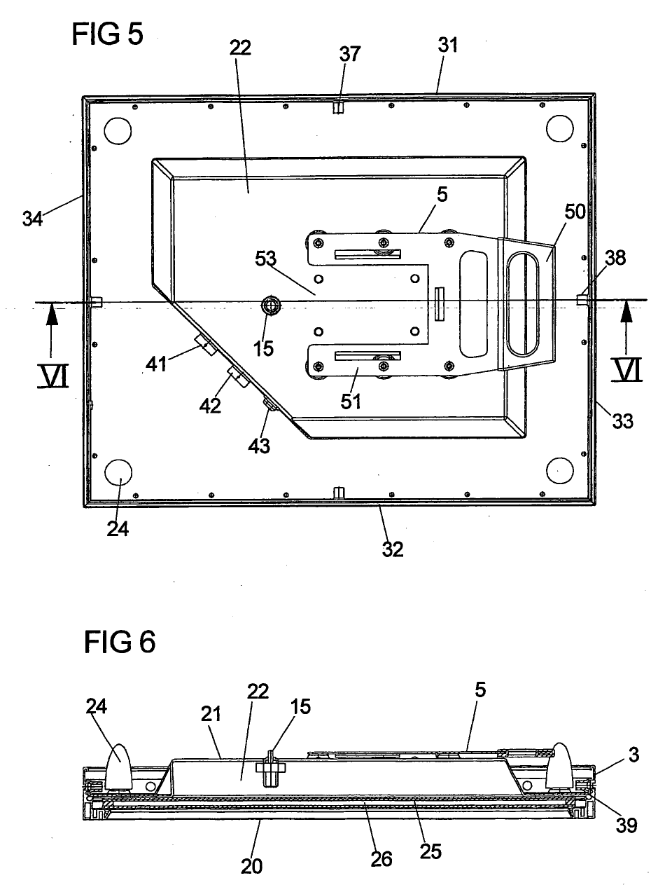

FIG. 6 a sectional view through the panel lamp module according to FIGS. 4 and 5 along the sectional line VI-VI according to FIG. 5;

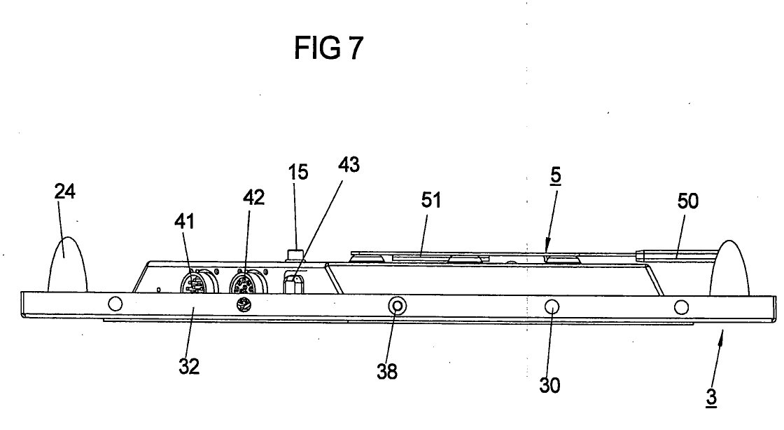

FIG. 7 a side view of the panel lamp module according to FIGS. 4 to 6;

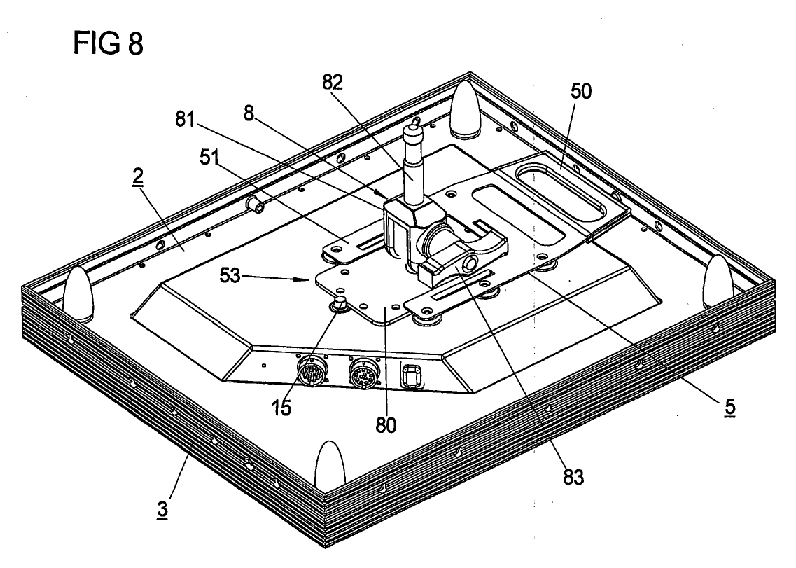

FIG. 8 a side view of the panel lamp module according to FIGS. 4 to 6 with a fixing means inserted in a socket guide plate;

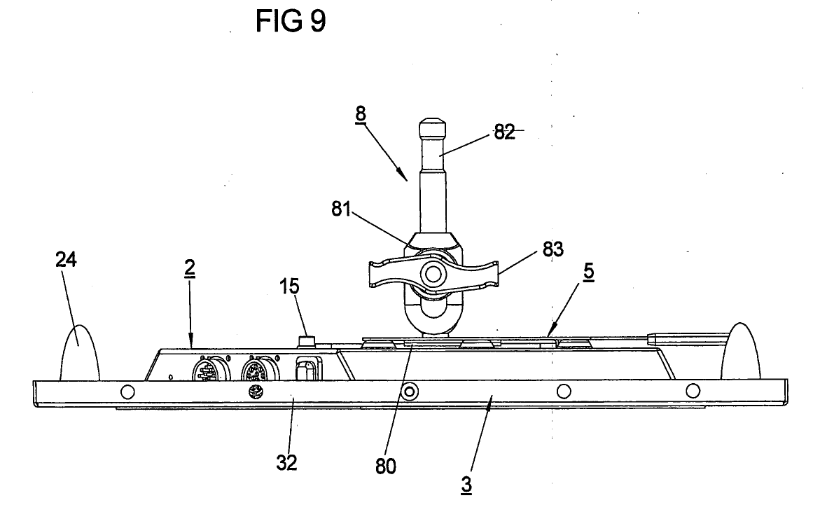

FIG. 9 a side view of the arrangement according to FIG. 8;

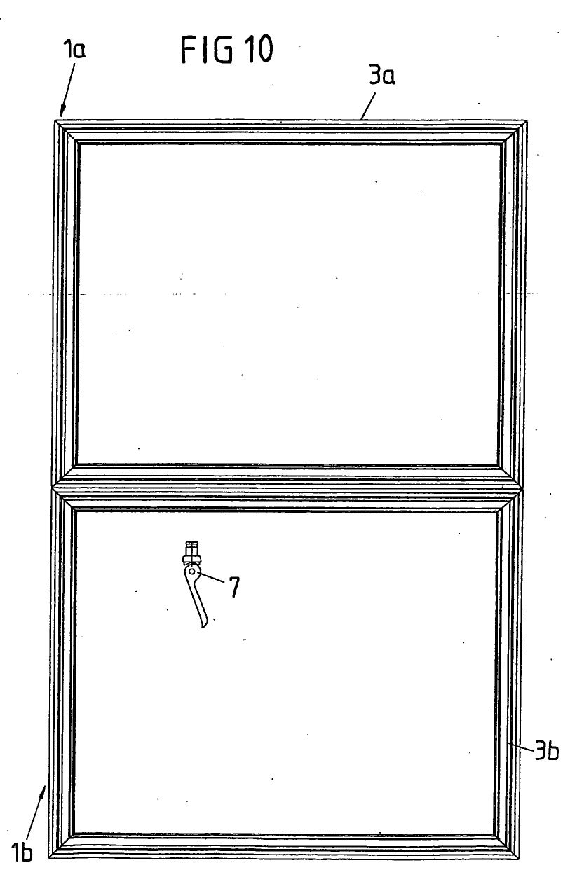

FIG. 10 a plan view of two panel lamp modules to be connected by means of a lateral connector;

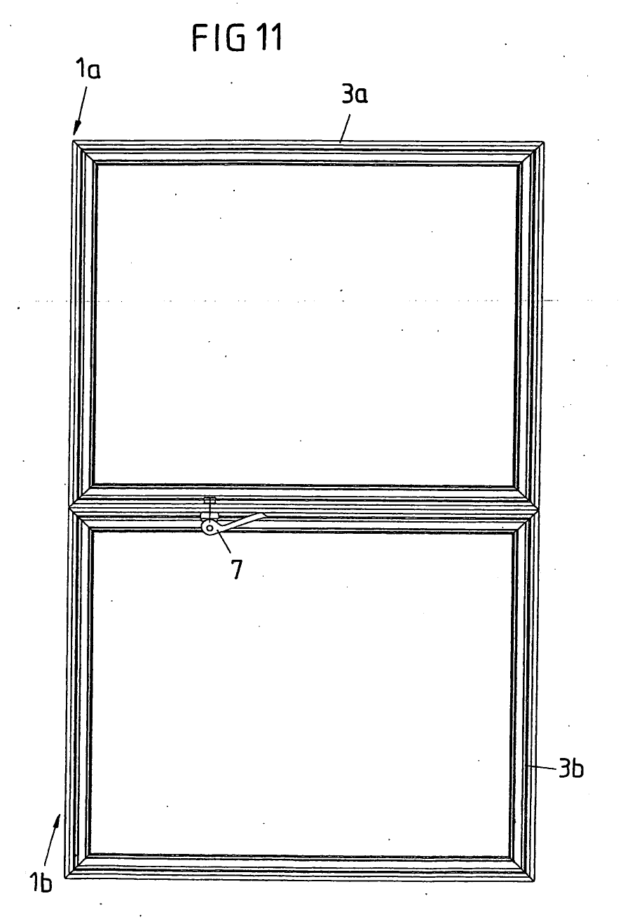

FIG. 11 a plan view of the two panel lamp modules connected by means of a lateral connector according to FIG. 10;

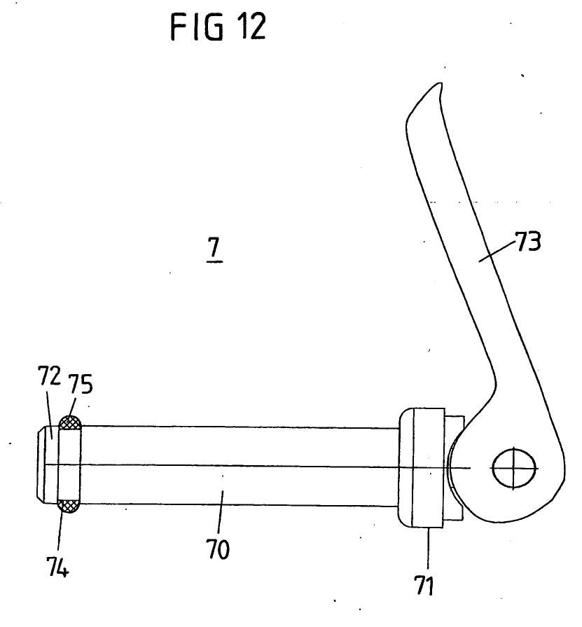

FIG. 12 shows an enlarged view of a lateral connector for connecting the lamp frames of panel lamp modules;

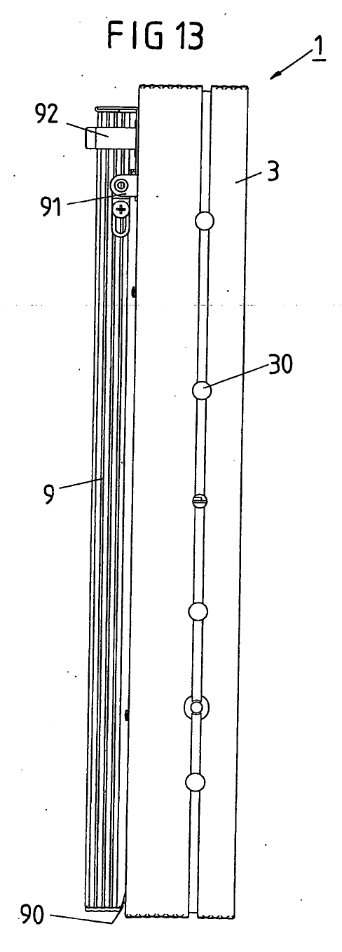

FIG. 13 shows a side view of the lamp frame of a panel lamp module with a hinged accessory frame folded up closed;

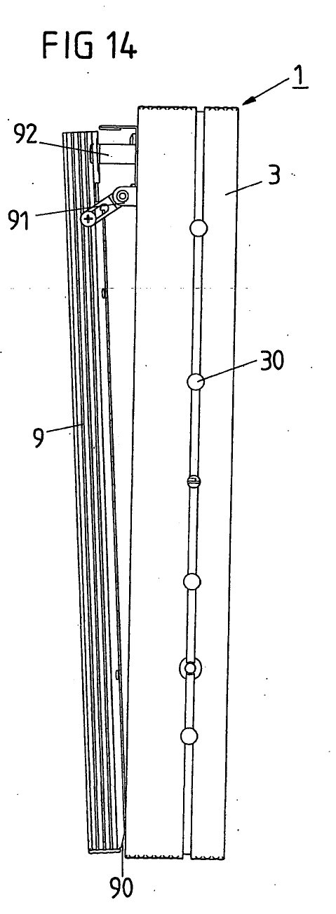

FIG. 14 shows a side view of the lamp frame according to FIG. 13 with a hinged accessory frame tilted away from the lamp frame;

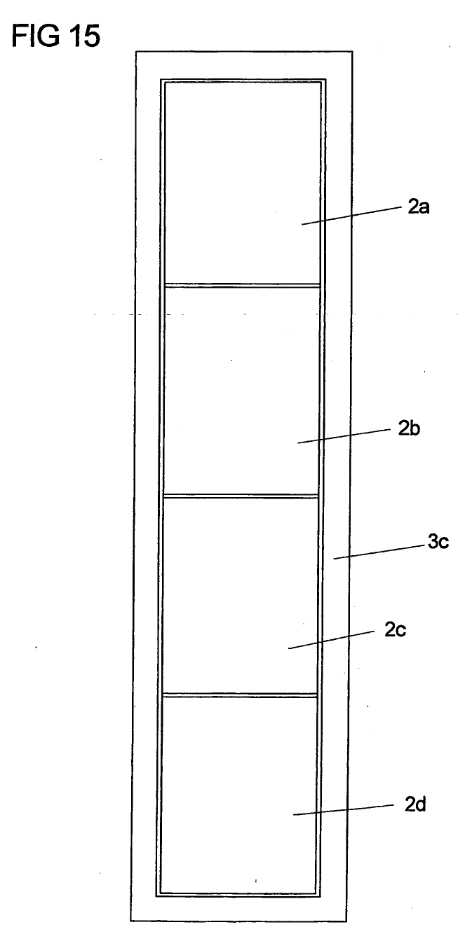

FIG. 15 shows a plan view of an illumination device comprising four lamp housings arranged superposed in one lamp frame and

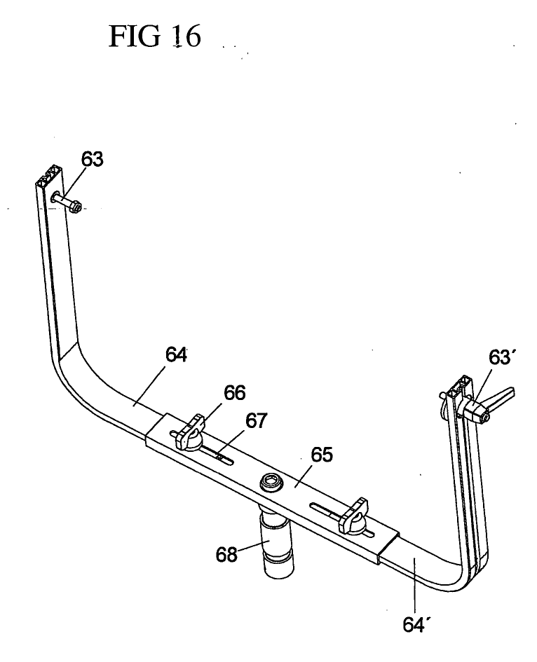

FIG. 16 shows a perspective view of a length-adjustable supporting bracket.

The illumination device according to the invention enables whilst retaining the principle of separating the panel lamp modules into a lamp housing and a lamp frame with a series connection several individual panel lamp modules to make up one large surface illumination device or with a series connection of several light housings inside a lamp frame encompassing all the light housings to make up one large surface illumination device with different design variations of which two different variations are shown in FIGS. 1 to 15, and will be described below, whilst FIGS. 13 and 14 show a connection of an illumination device to an accessory frame and FIG. 16 shows a fixing of the illumination device on a supporting bracket. The supporting bracket and the accessory frame can be used in all four variations described and illustrated.

FIGS. 1 to 3 show an illumination device comprising three panel lamp modules 1a, 1b, 1c of a modular expandable system using identical electrical panel lamp modules which are arranged one above the other and are connected together electrically and mechanically, and which correspond to the panel lamp module illustrated in a perspective rear view in FIG. 4 in a first embodiment and are connected together according to FIGS. 5 to 7.

The panel lamp modules 1a, 1b, 1c which are fixedly connected together and make up one unitary large surface illumination device create a large illumination surface area, as required for background illuminations or shadow-free illumination of persons and objects. The illumination device which is comprised of the three individual panel lamp modules 1a, 1b, 1c can be handled as one unit and can be connected to a tripod or ceiling holder through a holder 6 which is fixed on one of the panel lamp modules—in the illustrated embodiment the middle panel lamp module 1b.

To supply current to the illumination device or the individual panel lamp modules 1a, 1b, 1c and to control the panel lamp modules 1a, 1b, 1c a single cable 80 is used which is connected to a contact receiver element of the lower panel lamp module 1c and which is connected from there through cable connections 81, 82 to the additional panel lamp modules 1b and 1a. In this way it is possible to control and, depending on the technical lighting conditions, to dim, each one of the panel lamp modules 1a, 1b and 1c, two panel lamp modules, by way of example the panel lamp modules 1a and 1b, or all three panel lamp modules 1a, 1b, 1c.

As a result of the modular expansion of the panel lamp modules 1a, 1b, 1c over all four end sides it is possible to achieve any configuration of illumination device which is made up of the individual panel lamp modules 1a, 1b, 1c.

Since in a preferred embodiment the individual contact elements of the panel lamp modules 1a, 1b, 1c have in addition to the power supply contacts also a control and/or data bus which enables the individual panel lamp modules 1a, 1b, 1c to be addressed in any way, only a single cable slipping through the panel lamp modules 1a, 1b, 1c with cable sections 80, 81, 82 is required. Through this and through the type of connection of the individual panel lamp modules 1a, 1b, 1c with each other it is possible to achieve a simple construction of an illumination device designed as a planar lamp in practically any size and configuration.

The construction of the individual panel lamp modules 1a, 1b, 1c will now be described below with reference to FIG. 4 to 7.

FIG. 4 shows in a diagrammatic perspective illustration the rear view of a panel lamp module 1, FIG. 5 shows a plan view of the rear side of the panel lamp module, FIG. 6 shows a section through the panel lamp module along the sectional line VI-VI according to FIG. 5 and FIG. 7 shows a side view of the panel lamp module.

The rectangular or box-type module housing 10 is comprised of a lamp housing 2 and a lamp frame 3 running on the outside round the lamp housing 2 and having several assembly bores 30 spread out in the arms 31 to 34 of the lamp frame 3 for connection and modular expansion with the lamp frames 3 of further panel lamp modules. The lamp housing 2 is placed lower than the lamp frame 3 whereby the front side of the lamp housing 2 closes flush with the lamp frame 3.

The lamp housing 2 has a raised rectangular region 22 protruding from the rear wall 21 remote from the light-emitting surface of the lamp housing 2, with a diagonal side 23 spanning a corner of the raised region 22. The raised region 22 of the rear wall 21 serves to house the ballast as well as the lamp electronics for controlling and regulating the bulb which is mounted in the light housing. Through the incline of the raised surface 22 sufficient space is provided for the arrangement and electrical connection of the contact elements 41, 42 provided with the control electronics and ballast arranged inside the raised surface area 22, as well as for mounting an electrical switch 43 and for housing the connecting cables.

As spacers and for the flat bearing contact when attaching the panel lamp module 1 on a wall or shelf on a horizontal surface as well as for stacking several panel lamp modules, spacers 24 preferably designed as rubber buffers are arranged in the corner regions of the back wall 21 of the lamp housing 2 opposite the light-emitting front side so that a spot bearing contact is produced away from the light-emitting glass surface of the panel lamp modules 1.

In the case of a wall assembly the panel lamp modules lie on spacers 24 designed as rubber buffers. Since the spacers 24 project beyond the lamp frame 3 there is the possibility of hiding the connecting cables for the power supply and control of the individual panel lamp modules during wall assembly behind the panel lamp modules and thus out of sight behind the illumination device.

On the raised region 22 of the back wall 21 is a socket and guide plate 5 which is provided with a handle 50 preferably made of plastics and which has two side guide rails 51 whose ends mounted opposite the handle 50 form an insert opening 53. Centrally in front of the insert opening 53 is a locking element 15 in the form of a resilient pressure member. The task and function of the socket and guide plate 5 as well as of the locking element 15 will be explained in further detail below with reference to FIGS. 8 and 9.

FIG. 8 shows in a diagrammatic perspective view the back of a panel lamp module as described above with reference to FIGS. 4 to 7 whilst FIG. 9 shows a side view of same.

A fixing element 8 which is inserted into the socket of the guide plate 5 consists of a fixing plate 80, a connecting body 81 connected to the fixing plate 80, a pivotal stud 82 and a tension element 83. The fixing plate 80 is fitted onto the locking element for connection with the socket and guide plate 5 and presses down this locking element 15, which is preferably designed as a resilient pressure member, on sliding into the side guide rails 51 of the socket and guide plate 5. If the fixing element 8 is fully inserted into the socket and guide plate 5 then the resilient pressure member 15 engages in an opening of the fixing plate 80 or—as shown in the embodiment according to FIG. 8—bears against the outside edge of the fixing plate 80.

In order to separate the fixing element 8 from the socket and guide plate 5 the locking element 15 is released by pressing down the locking element 15 which is designed as a resilient pressure member and withdrawing the fixing plate 80 by sliding it out from the socket and guide plate 5 over the locking element 15.

In the embodiment illustrated in FIGS. 8 and 9 the fixing element has a pivotal stud 82 which can be locked in any angular position by means of the tension element 83. The pivotal stud 82 can be inserted and locked in a socket sleeve of a tripod or other fixing device for holding the panel lamp module.

Both standardized embodiments and special fixing devices such as for example clamping devices or the like can be provided as fixing elements 8.

The connection of several panel lamp modules 1 of the first design illustrated in FIGS. 4 to 9 into one planar illumination device is shown diagrammatically in FIGS. 10 and 11.

The end sides of two lamp frames 3a, 3b of two panel lamp modules 1a, 1b placed against each other are fixedly connected by means of one or more lateral connectors 7 fitted in through assembly bores 30 according to FIG. 4 whereby FIG. 10 shows the connection of the two panel lamp modules 1a, 1b before the lateral connector 7 engages whilst FIG. 11 shows the connection of the panel lamp modules 1a, 1b after the lateral connector engages.

FIG. 12 shows the construction of a lateral connector which consists of a hollow cylindrical connecting body 70, a stop shoulder 71 mounted at one end of the hollow cylindrical connecting body 70, a contact bearing member 72 which is connected through a connecting rod to a lever 73 mounted on the shoulder 71, and an elastic ring 75 inserted in the groove 74 formed between the contact bearing member 72 and the end of the hollow cylindrical connecting body 70. With the position of the lever 73 illustrated in FIG. 12 which corresponds to the position shown in FIG. 11 the contact bearing member 72 is tightened against the end of the hollow cylindrical connecting body 70 so that the groove 74 formed between the bearing member and the end of the hollow cylindrical connecting body 70 is made smaller and thus the elastic ring 75 is widened out. A restriction is thereby formed between the widened elastic ring 75 and the bearing shoulder 71 which according to the illustration in FIG. 11 connects the lamp frames 3a and 3b of the panel lamp modules 1a, 1b together.

By turning the lever 73 round into a position which lies in the extension of the cylindrical connecting body 70 corresponding to the illustration in FIG. 10, the groove 74 is widened out and thus the expansion of the elastic ring 75 is eliminated. Since the outer diameter of the hollow cylindrical connecting body 70 and the outer diameter of the relaxed elastic ring 75 are smaller than the diameter of the assembly bores 70 in the arms of the lamp frame, the lateral connector 7 can be pushed through the aligned assembly bores 30 of the lamp frames 3a, 3b of the panel lamp modules 1a, 1b which are to be connected according to FIG. 10.

After pushing the lateral connector 7 through the aligned assembly bores 30 of the lamp frames 3a, 3b the lever 73 is pivoted into the position shown in FIGS. 11 and 12 in which the contact bearing member 72 is tightened and thus the elastic ring 75 is widened out.

Through a corresponding matching length between the end sides of the lamp frames 3a, 3b which are to be connected and the length of the gap between the expanded elastic ring 75 and the bearing shoulder 71 a fixed positive locking detent connection is produced between the lamp frames 3a, 3b according to FIG. 11.

As an alternative to the connection of the lamp frames 3a, 3b by means of a lateral connector it is also possible to produce a solid positive-locking and force-locking connection by means of screws and nuts which is particularly advantageous in the case of a fixed wall or ceiling mounting of the illumination device.

Further alternatives are bayonet locking connections between the individual lamp frames or through corresponding profiling of the outer side of the lamp frames to produce dovetailed connections.

For light control the lamp frame 3 of the panel lamp modules 1 can according to FIGS. 13 and 14 additionally be connected to a movable accessory frame 9 to hold filter discs, colour filters, shutters and the like. The connection is through a push-fit or hinge connection 90 on one of the end sides of the lamp frame 3 as well as through a folding hinge 91 and a securing element 92. FIG. 13 shows the accessory frame 9 in the fitted secured position whilst FIG. 14 shows a side view of the lamp frame 3 with an accessory frame 9 unfolded so that easy exchange of for example filter discs, colour changers, lenses or colour foils is possible.

As an alternative to the connection of several panel lamp modules each comprising a lamp housing and a lamp frame it is possible as a result of making up panel lamp modules from lamp frames and lamp housings also to make up several lamp housings arranged above and/or side by side each other in one lamp frame encompassing all the lamp housings into one large-surface illumination device. Two possible variations are shown in FIGS. 15 and 16 and will be explained in further detail below.

FIG. 15 shows an illumination device consisting of four lamp housings 2a to 2d which are connected together mechanically in one lamp frame 3c encompassing the lamp housings 2a to 2d. The electrical connection of the lamp housings 2a to 2d takes place in the manner described above through control and power supply cables placed on the back wall of the lamp housings 2a to 2d. The four lamp housings 2a to 2d which are arranged one above the other are also connected at the sides and in relation to the topmost and lowest lamp housings 2a and 2d in the manner described above on one end side to the lamp frame 3c. The gaps between the lamp housings 2a to 2d can be closed by permanent elastic plastics such as for example silicon. As an alternative the connection is possible through suitable elastic intermediate pieces or through webs which are connected at the sides to the lamp frame 3c and in which the lamp housings 2a to 2d can be inserted similar to the connection illustrated in FIG. 16.

In order to connect an individual panel lamp module or an illumination device comprised of several panel lamp modules described above to a tripod or a wall or ceiling fixing it is possible in addition to the type of connection described above with reference to FIGS. 8 and 9 through the back wall of the panel lamp modules to provide a holder 6 designed as a supporting bracket according to FIG. 16 which is connected to positive or force locking elements 37, 38 on the side arms of the lamp frame 3. The connection is through counter positive locking elements or counter force locking elements 63,63′ which are provided at the ends of the arms 64, 64′ of the supporting bracket 6 and are designed to fit into the positive locking or force locking elements 37, 38 of the lamp frame 3.

The connection can thereby be produced either through the short or long axis of the panel lamp module since the supporting bracket 6 according to FIG. 16 is designed to be adjusted in length so that the ends of the bracket can be set at different spacing relative to each other. For this the arms 64, 64′ of the supporting bracket are inserted in a centre piece 65 of the bracket which has two oblong holes 67 in which wing nuts 66 connected to the bracket arms 64, 64′ are inserted. By loosening the wing nuts 66 the arms 64, 64′ of the supporting bracket can be moved inside the centre piece 65 of the bracket so that the distance between the ends of the arms 64, 64′ can be set relative to each other.

The centre piece 65 of the supporting bracket is connected to a connecting sleeve or a connecting bolt 68 which can be inserted into a wall, ceiling or tripod fixing. The illumination device connected to the supporting bracket 6 or the panel lamp module connected to the bracket 6 can thus be pivoted in any way about the axis which is formed through the counter positive locking elements or counter force locking elements 63, 63′ of the supporting bracket 6. Since the connection between the centre piece 65 of the bracket and the connecting sleeve or connecting bolt 68 is rotatable the illumination device can also be pivoted about the axis which is formed through the connecting sleeve or connecting bolt 68.

1. Illumination device consisting of at least two electrical panel lamp modules (1; 1a, 1b, 1c) which have a module housing (10), whose housing depth is small compared with the light-emitting front side (20) of the panel lamp module (1; 1a, 1b, 1c), and which consists of a lamp housing (2; 2a-2e) and a lamp frame (3; 3a-3d) having a greater depth and surrounding the lamp housing (2; 2a-2e) on the outside and having several arms (31-34) in which assembly bores (30) are disposed which are spread out and for modular expansion align with the assembly bores (30) in the arms (31-34) of adjoining lamp frames (3; 3a-3d) and through which connecting elements (7) can be pushed which connect the lamp frames (3; 3a-3d) together with positive-locking and/or force-locking engagement.

2. Illumination device according to claim 1, characterised in that the lamp housing (2; 2a-2e) closes on its front side flush with the lamp frame (3; 3a-3d).

3. Illumination device according to claim 1, characterised in that the lamp housing (2; 2a-2e) can be inserted in the lamp frame (3; 3a-3d).

4. Illumination device according to claim 1, characterised in that the connecting elements consist of lateral connectors (7) with a cylindrical connecting body (70) whose diameter is smaller than the diameter of the assembly bores (30), a stop shoulder (71) mounted at one end of the cylindrical connecting body (70), a lever (73), and of a bolt (72) connected to the lever (73) and guided through the cylindrical connecting body (70) wherein a groove (74) is formed between the end of the bolt and the end of the cylindrical connecting body (70) wherein the width of the groove can be changed by actuating the lever (73) and the groove contains an elastic ring (75) which can be expanded through compression.

5. Illumination device according to claim 4, characterised in that the connecting elements (7) consist of screws and nuts which can be screwed thereto.

6. Illumination device according to claim 1, characterised in that spacers (24), preferably designed as rubber buffers and whose outer ends project beyond the lamp frame (2) are arranged in the corner regions of the rear wall (21) of the lamp housing (2; 2a-2e) opposite the light-emitting front side (20).

7. Illumination device according to claim 1, characterised in that the lamp housing (2) consists of a light housing (26) for holding a planar lamp, a heat distribution plate (25) on the rear side of the light housing (26) opposite the light-emitting front side of the lamp housing (2), and of a rear wall (21).

8. Illumination device according to claim 1, characterised in that on the rear wall (21) of the lamp housing (2) there is at least one contact element (41) and at least one contact receiver element (42) for controlling and supplying current to the panel lamp module (1; 1a, 1b, 1c).

9. Illumination device according to claim 8, characterised in that the rear wall (21) of the lamp housing (2) has a central raised region (22) and that the at least one contact element (41) and contact receiver element (42) are designed multi-polar and are arranged on an end side (23) of the raised region (22).

10. Illumination device according to claim 9, characterised in that the central raised region (22) is rectangular with a diagonal side (23) bridging one corner and that the at least one contact element (41) and contact receiver element (42) are arranged on the diagonal side (23).

11. Illumination device according to claim 1, characterised in that the panel lamp modules (1; 1a, 1b, 1c) can be connected to a power supply module through cable connections (80-82).

12. Illumination device according to claim 1, characterised in that the electrical panel lamp modules (1; 1a, 1b, 1c) which are arranged modular in a row can be controlled individually.

13. Illumination device according to claim 1, characterised in that the contact elements (41, 42; 44, 45) have a number of contacts for the individual control and power supply of the individual electrical panel lamp modules (1; 1a, 1b, 1c) arranged in series which (number) corresponds to the number of electrical panel lamp modules (1; 1a, 1b, 1c) which are arranged in series.

14. Illumination device according to claim 1, characterised in that the contact elements (41, 42; 44, 45) have power supply contacts connected to the power supply module, and a control and/or data bus through which the electrical panel lamp modules (1; 1a1, 1b, 1c) arranged in series can be addressed and controlled individually.

15. Illumination device according to claim 1, characterised by an electrical switch (43) assigned to each panel lamp module (1; 1a, 1b, 1c) for individual activation of the panel lamp module (1; 1a1, 1b, 1c).

16. Illumination device according to claim 1, characterised in that the lamp frame (3) can be connected on the light-emitting front side (20) of the lamp housing (2) to an accessory frame (9) for holding a filter, shutter, colour foil or the like.

17. Illumination device according to claim 16, characterised in that the accessory frame (9) connected to the lamp frame (3) can be unfolded away from the lamp frame (3).

18. Illumination device according to claim 1, characterised in that the lamp frame (3) can be connected to a holder (6) which holds the illumination device.

19. Illumination device according to claim 18, characterised in that the arms (31-34) of the lamp frame (3) preferably have in the middle a positive locking or force locking engagement element (37, 38) and that the holder consists of a supporting bracket (6) whose ends are provided with counter positive locking elements or counter force locking engagement elements (63).

20. Illumination device according to claim 19, characterised in that the supporting bracket (6) is adjustable in length.

21. Illumination device according to claim 1, characterised in that the rear wall (21) of the lamp housing (2) is provided with a socket and guide plate (5) in which a fixing element (8) can be inserted which can be connected to the panel lamp module (1; 1a, 1b, 1c).

22. Illumination device according to claim 21, characterised in that the socket and guide plate (5) has at least two guide rails (51, 52) which are arranged on either side of an insert opening (53) and that a locking element (15) is mounted on the rear wall (21) of the lamp housing (2) in the insert direction of the fixing element (8) in front of the insert opening (53).

23. Illumination device according to claim 22, characterised in that the locking element consists of a resilient pressure member (15).

24. Illumination device according to claim 22, characterised in that a handle (50) is formed on the side of the guide plate (5) opposite the insert opening (53).

25. Illumination device according to claim 1, characterised by the use of a flat discharge lamp as the panel lamp module (1; 1a, 1b, 1c).
